(19) United States
(12) Patent Application Publication
(10) Pub. No.: US 2009/0094312 A1
(43) Pub. Date: Apr. 9, 2009

(54) METHODS AND SYSTEMS FOR DYNAMIC CODE EXTENSION

(76) Inventors: John J. POWLEY, Plainville, MA (US); Robert GENDRON, Salem, MA (US)

Correspondence Address: General Electric Company;GE Global Patent Operation, PO Box 861, 2 Corporate Drive, Suite 648, Shelton, CT, 06484, US

(21) Appl. No.: 11/866,507

(22) Filed: Oct. 3, 2007

(51) Int. Cl. G06F 15/16; G06F 17/30

(52) U.S. Cl. 709/203; 707/3

(57) ABSTRACT

A method for normalizing client interactions with service providers is provided. The method includes receiving a request for a desired service provider method interface from a client, searching a directory for an extender that is associated with the desired service provider method, and returning a proxy to the client, the proxy including at least one of an extender execution path and a method execution path.

### BACKGROUND OF THE INVENTION

The methods and systems described herein relate generally to client software interfaces used to communicate within a system and, more specifically, to providing consistent functionality to an end user.

At least some known distributed application environments are based on a Service Oriented Architecture (SOA), wherein software functionality consists of client code that leverages the capabilities of registered service providers on a network. In large-scale environments, it becomes very challenging to ensure consistent functional behavior across all service providers. Additionally, at least some known distributed application environments include an increasing number of multi-vendor software components. It is increasingly difficult to provide a consistent functional behavior using current software architectures.

At least some known distributed application environments have used functional abstraction techniques to build consistency. A dedicated service provides a function and all services that also use the function are required to make calls to the hosting service where and when appropriate. This requires developers to continually monitor the need to modify existing methods to add, change, or delete calls to outside services. Such a need can lead to inconsistent use of the service functionality and possible omissions, wherein a call to the service should be made and is not.

Moreover, some vendors provide attribute classes that allow developers to modify, or “mark up,” the vendor service provider methods. This may make it easier to ensure that the proper functionality is being called at appropriate times. However, this technique also relies heavily on developers to have a complete understanding of the circumstances in which a call to the service provider should be made. Additionally, after the code is compiled there is no way to check the functionality during operation. Further, any changes made to the calling service then requires the code to be recompiled and re-installed.

Another technique that has been used is Aspect Oriented Programming (AOP). AOP uses the output of one method to trigger the execution of another method. However, this technology also requires a re-compilation when a method is changed.

A technology known as “plug-ins” is another technique that has been used to extend the functionality of a base application. However, a “plug-in” must be called through a user action, such as a button push, or by hooking to an event in the base application. Moreover, “plug-ins” do not run within the same execution path of a desired method and therefore cannot affect the behavior of that method.

### BRIEF DESCRIPTION OF THE INVENTION

In one aspect, a method for normalizing client interactions with service providers is provided. The method includes receiving a request for a desired service provider method interface from a client, searching a directory for an extender that is associated with the desired service provider method, and returning a proxy to the client, the proxy including at least one of an extender execution path and a method execution path.

In another aspect, a data communication system includes at least one client and a server communicatively coupled to the at least one client. The server includes a plurality of service providers, a plurality of extenders, and a directory, and the server is configured to: search the directory for at least one extender of the plurality of extenders, wherein the at least one extender is associated with a client-specified service provider of the plurality of service providers, build a proxy including at least one of an execution path for the at least one extender and an execution path for a method, execute the method using the proxy, and transmit execution results of the method to the at least one client for display to a user.

In another aspect, a computer program embodied on a computer-readable medium is provided, including at least one code segment configured to instruct a computer to inject one of an application server method execution path and an extender into a service provider method execution path. The computer program is configured to search a directory for at least one extender registered in association with a service provider and build a proxy including at least one of the service provider method execution path, an extender execution path, and the application server method execution path.

### BRIEF DESCRIPTION OF THE DRAWINGS

FIGS. 1-3 show exemplary embodiments of the systems and methods described herein. The systems and methods shown in FIGS. 1-3 and described in conjunction with FIGS. 1-3 are exemplary only.

FIG. 1 is a schematic diagram of an exemplary Service Oriented Architecture system for constructing a proxy;

FIG. 2 is a schematic diagram of an exemplary hardware architecture for the system shown in FIG. 1; and

FIG. 3 is a flow chart illustrating an exemplary method of constructing a proxy using the system and hardware architecture shown in FIGS. 1 and 2.

### DETAILED DESCRIPTION OF THE INVENTION

The technical effect of the described embodiments is to provide systems and methods for dynamically constructing a proxy for a client to call a service provider method in an automated system, which is configured to perform base services. In the exemplary embodiment, the system includes a directory of service providers. The service providers include machines included in the automated system and programming services that are used to support the machines. The system links the service providers based on common programmability and integrates the service providers to perform base services of the automated system.

As used herein, the terms “container,” “application server,” and “server” are used to describe a central host for a Service Oriented Architecture (SOA) system. Moreover, as used herein, the terms “site,” “service provider,” and “service” are used to describe a collection or set of objects in an SOA system. Additionally, as used herein, the terms “object” and “method” are used to describe executable code.

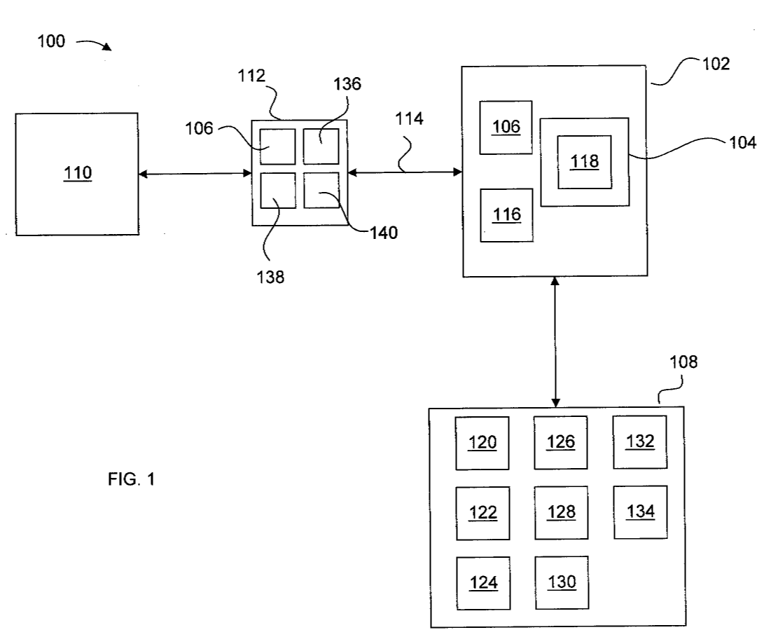

FIG. 1 is a schematic diagram of an exemplary Service Oriented Architecture (SOA) system 100 for constructing a proxy. System 100 includes at least one application server 102, at least one service provider 104, at least one extender 106, and a directory 108. System 100 also includes at least one client 110 and at least one proxy 112. System 100 is connected by a network 114.

In the exemplary embodiment, application server 102 includes at least one service provider 104, at least one extender 106, and at least one application server method 116. Application server 102 hosts multiple kinds of software service providers 104 such as, but not limited to, multiple protocols, Transmission Control Protocol (TCP), and/or Service Oriented Architecture Protocol (SOAP). Application server 102 is responsible for loading and unloading operations in system 100. More specifically, application server 102 is responsible for loading service provider 104 so that a method belonging to service provider 104 may be executed. Application server 102 is also responsible for unloading running service provider 104 by stopping and removing a running method from the application server's 102 memory space. Further, application server 102 is responsible for updating service provider 104, wherein application server 102 detects a new version of service provider 104 and determines whether to load the new version. In the exemplary embodiment, application server 102 also supports enumeration of running services and provides access control of the services.

In the exemplary embodiment, each service provider 104 includes at least one object. Service provider 104 supports access to each object which may be, for example, a method 118.

In the exemplary embodiment, an extender 106 is a functional behavior which may be embodied by, for example, a code fragment or method. An extender 106 may be injected into the execution capabilities of service provider 104 and/or service provider method 118.

In the exemplary embodiment, directory 108 includes necessary information about service provider 104. In the exemplary embodiment, directory 108 includes a location 120 for loading each service provider 104. Location 120 is shown as a path to service provider 104 or service provider method 118. Directory 108 also includes any dependencies 122 of service provider 104. In one embodiment, service provider 104 depends on at least one additional service provider 104. In an alternative embodiment, service provider 104 depends on at least one extender 106. In a further alternative embodiment, service provider 104 depends on at least one additional service provider 104 and at least one extender 106. In yet another alternative, embodiment service provider 104 has no dependencies 122. Directory 108 also includes factory information 124 of each service provider 104. Factory information 124 includes any additional data that may be required to load and/or execute service provider method 118 such as, but not limited to, a required status of a particular parameter used by service provider method 118. Further, directory 108 includes a list of interfaces 126 supported by each service provider 104 and a unique name 128 for each service provider 104. Unique name 128 allows service provider 104 to be addressed from anywhere within system 100.

Moreover, in the exemplary embodiment, directory 108 includes all necessary information about an extender, such as extender 106. In the exemplary embodiment, directory 108 includes a location 130 for loading each extender 106. Location 130 is shown as a path to an extender 106. Directory 108 also includes any dependencies 132 of each extender 106. In one embodiment, extender 106 depends on at least one service provider 104. In an alternative embodiment, extender 106 depends on at least one additional extender 106. In a further alternative embodiment, extender 106 depends on at least one service provider 104 and at least one additional extender 106. Directory 108 also includes for each extender 106 a list of which service providers 104 are associated with extender 106. In one embodiment, extender 106 is associated with all service providers 104. In an alternative embodiment, service providers 104 are divided into classes in a given manner and each extender 106 is associated with at least one class. In a further alternative embodiment, extender 106 is associated with an individual service provider 104. In yet another alternative embodiment, extender 106 is associated with one or more service providers 104 according to the embodiments described above. Additionally, each extender 106 is characterized as one of a client proxy, a server proxy, and a client-server proxy.

In the exemplary embodiment, each proxy 112 includes all necessary code to gather parameters 134 needed to execute a desired service provider method 118 and to transport parameters 134 across network 114 to and from client 110 and application server 102. In the exemplary embodiment, one such parameter 134 is a service provider method execution path 136, which is an address for executable code of a corresponding service provider method 118. In one embodiment, proxy 112 includes only service provider method execution path 136. In an alternative embodiment, proxy 112 includes service provider method execution path 136 and extender execution path 138, which is an address for executable code of extender 106. In another alternative embodiment, proxy 112 includes application server method execution path 140 and service provider method execution path 136. In a further alternative embodiment, proxy 112 includes service provider method execution path 136, extender method execution path 138, and application server method execution path 140. Using proxy 112 enables new functionality to be added to service provider 104 and/or service provider method 118 at any time by executing extender 106 that exhibits the desired functionality. New functionality may also be added to service provider 104 and/or service provider method 118 by executing application server method 116 which, in turn, may then execute extender 106. Moreover, adding extender 106 into service provider method execution path 136 of a desired service provider method 118 alleviates the need to recompile service provider method 118 and/or service provider 104 to which method 118 belongs. Further, extender 106 enables service providers 104 from various vendors to exhibit at least one expected behavior in common.

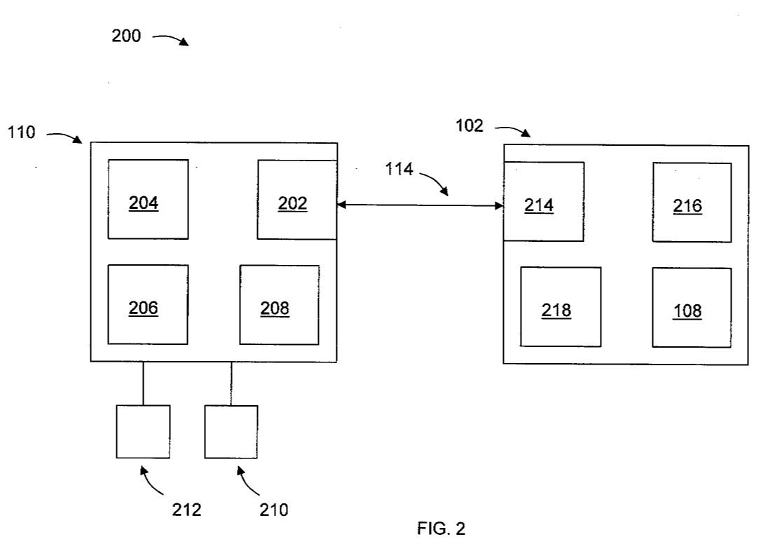

FIG. 2 is a schematic diagram of an exemplary system hardware architecture 200 for system 100 (shown in FIG. 1). Architecture 200 can be implemented on many different platforms and utilize many different architectures. Architecture 200 as illustrated in FIG. 2 is exemplary only. In the exemplary embodiment, architecture 200 includes at least one client 110 and at least one application server 102. Architecture 200 is interconnected by network 114. In one embodiment, network 114 is a wide area network (WAN), such as the Internet. In an alternative embodiment, network 114 is a local area network (LAN), such as an intranet. Network 114 includes the physical medium and intermediate devices (not shown), such as routers and switches, that connect the elements of architecture 200 described above.

Client 110 is communicatively connected to network 114 via a network interface 202. A user accesses, such as dialing into, or directly logging into, an intranet or the Internet to gain access to system 200. Client 110 may connect to network 114 through many interfaces including a different network (not shown), such as a WAN or a LAN, dial in connections, cable modems, wireless networks, and special high-speed ISDN lines. Client 110 is any device capable of interconnecting to network 114, including a web-based telephone or other web-based connectable equipment. Client 110 may be a stand-alone client, such as a thin client, that runs only an operating system and an application 204 for accessing and communicating with architecture 200. Alternatively, client 110 may operate as application 204 installed on a personal computer (PC) and may run similarly and/or concurrently with other programs. Client 110 also includes a system memory 206 electrically connected to a system bus (not shown) and, in one embodiment, includes an operating system and a user-oriented program and data. In the exemplary embodiment, client 110 also includes user interaction devices such as a display 208, a keyboard 210, and a mouse 212.

Application server 102 is communicatively coupled to network 114 via a network interface 214. Application server 102 includes a system memory 216 electrically connected to a system bus (not shown) and, in one embodiment, includes an operating system. In the exemplary embodiment, memory 216 includes directory 108. More specifically, directory 108, as described above, includes all necessary information about at least one service provider 104 and at least one extender 106 (both shown in FIG. 1). In the exemplary embodiment, application server 102 also includes at least one processor 218 which supports enumeration of running service providers 104. For example, a directory service running continuously on application server 102 facilitates searching directory 108 for information about a desired service provider 104 and/or a desired extender 106.

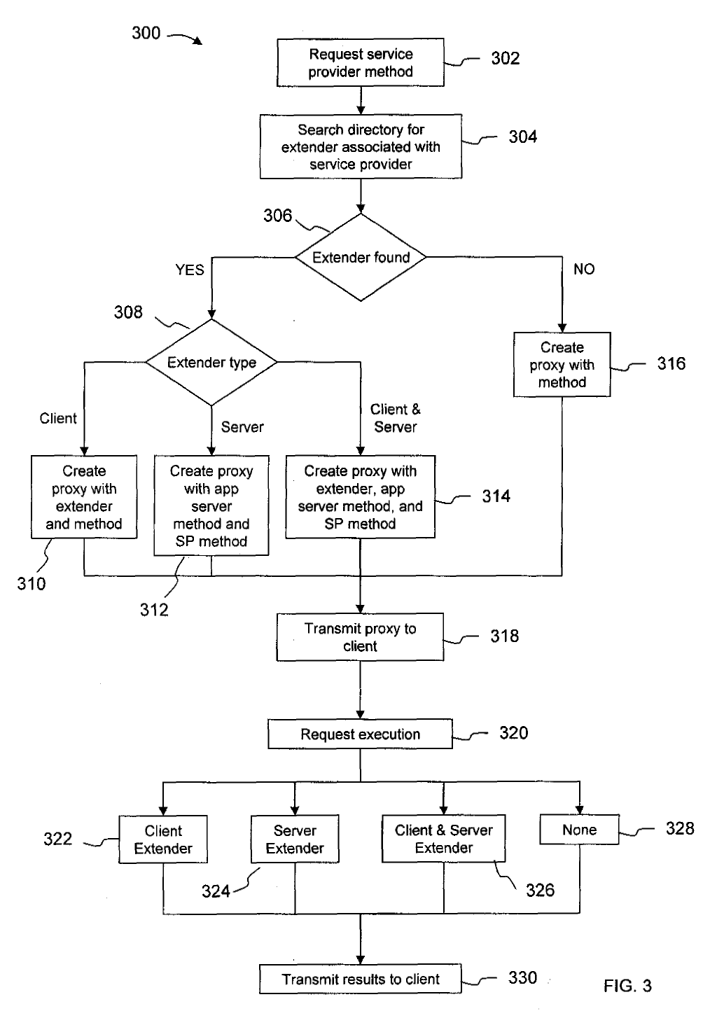

FIG. 3 is a flow chart illustrating an exemplary method 300 of constructing a proxy, such as proxy 112 (shown in FIG. 1) using system 100 and system hardware architecture 200 (shown in FIG. 2).

Referring to FIGS. 1 and 2, each client 110 includes a number of active applications 204 during normal operation. In one embodiment, application 204 is a web browser running a program for communicating with system 100. In an alternative embodiment, application 204 is a standalone application for communicating with system 100. Using application 204, a user requests 302 information for running a desired service provider method 118. The client request is transmitted over network 114 to application server 102.

Upon receiving the client request, a running service provider 104 on application server 102, such as a directory service, searches 304 directory 108 for information relating to service provider method 118. In one embodiment, information relating to service provider method 118 includes service provider method execution path 136 and/or whether extender 106 is associated with service provider 104 that is the parent of method 118. In order to search directory 108, each service provider 104 and extender 106 must be registered in directory 108. In registering service provider 104 in directory 108, information is inserted into directory 108 describing service provider 104. For example, for each service provider 104, directory 108 includes location 120 for loading each service provider 104 in server memory 216. Location 120 is shown as a path to service provider 104 or service provider method 116. Directory 108 also includes any dependencies 122 of each service provider 104, factory information 124 of each service provider 104, a list of interfaces 126 supported by each service provider 104, and a unique name 128 for each service provider 104. Additionally, for each extender 106, directory 108 includes location 130 for loading each extender 106. Location 130 is shown as a path to extender 106. Directory 108 also includes any dependencies 132 of each extender 106, and a list for each extender 106 of which service providers 104 are associated with extender 106. Moreover, directory 108 includes a characterization of each extender 106 as being a client-side extender, a server-side extender, or an extender that is both client and server related.

Moreover, in order for the directory service to search 304 for extender 106 associated with the desired service provider method 118, each extender 106 must be linked and/or associated with at least one service provider 104. Extender 106 associated with a specific service provider 104 will also be associated with service provider methods 118 belonging to the specific service provider 104. Extender 106 may also be associated with one or more application server methods 116.

If the directory service finds 306 extender 106 associated with desired service provider 104 and/or application server method 116, application server 102 determines 308 a type of proxy 112 to construct. More specifically, application server 102 determines 308 from directory 108 whether extender 106 is a client-side extender, a server-side extender, or an extender that applies to both a client and a server. Application server 102 constructs proxy 112 according to this determination 308. Specifically, if extender 106 is a client-side extender, application server 102 constructs 310 a client-only proxy that includes at least extender execution path 138 and service provider method execution path 136. Similarly, if extender 106 is a server-side extender, application server 102 constructs 312 a server-side proxy that includes at least application server method execution path 140 and service provider method execution path 136. Additionally, if extender 106 relates to both application server 102 and client 110, application server 102 constructs 314 a client-server proxy that includes at least service provider method execution path 136, application server method execution path 140, and extender execution path 138. On the other hand, if the directory service does not find 306 extender 106 associated with either desired service provider 104 or application server method 116, proxy 112 is constructed 316 by application server 102 such that the proxy 112 includes at least service provider method execution path 136 but does not include extender execution path 138 or application server method execution path 140.

The constructed proxy 112 is then transmitted 318 by application server 102 to client 110. Client application 204 then requests 320 that the desired service provider method 118 be executed using proxy 112. If proxy 112 is a client-side proxy, client 110 transmits proxy 112 and any input parameters 134 necessary for executing service provider method 118 and/or extender 106, to application server 102. Client 110 then executes 322 extender 106 using extender execution path 138 and any necessary input parameters 134. Once extender 106 has been executed, application server 102 executes 322 service provider method 118 using service provider method execution path 136 and any necessary input parameters 134. Application server 102 then transmits 330 the results to client 110 for display to a user using application 204 and display 208.

If proxy 112 is a server-side proxy, client 110 transmits proxy 112 and any input parameters 134 necessary for executing application server method 116 and/or service provider method 118, to application server 102. Application server 102 then executes 324 application server method 116 using application server method execution path 140 and any necessary input parameters 134. For example, application server method 116 is directed to search for an extender 106, which is then executed by application server 102 using extender execution path 138. Once application server method 116 and/or extender 106 have been executed, application server 102 executes 324 service provider method 118 using service provider method execution path 136 and any necessary input parameters 134. Application sever 102 then transmits 330 the results to client 110 for display to a user using application 204 and display 208.

Moreover, if proxy 112 is related to both client 110 and application server 102, client 110 transmits proxy 112 and any input parameters 134 necessary for executing application server method 116, extender 106, and/or service provider method 118, to application server 102. In one embodiment, application server 102 then executes 326 extender 106 using extender execution path 138, executes 326 application server method 116, as described above, using application server method execution path 140 and any necessary input parameters 134, and then executes 326 service provider method 118 using service provider method execution path 136 and any necessary input parameters 134. In an alternative embodiment, application server 102 executes 326 application server method 116, as described above, using application server method execution path 140 and any necessary input parameters 134, executes 326 extender 106 using extender execution path 138, and then executes 326 service provider method 118 using service provider method execution path 136 and any necessary input parameters 134. Application sever 102 then transmits 330 the results to client 110 for display to a user using application 204 and display 208.

If the constructed proxy 112 does not include extender 106, client 110 transmits proxy 112 and any input parameters 134 necessary for executing service provider method 118, to application server 102. Application server 102 then executes 328 service provider method 118 using service provider method execution path 136 and any necessary input parameters 134, and transmits the results to client 110 for display to a user using application 204 and display 208.

The above-described embodiments of methods and systems for dynamically constructing a proxy used during requests by system clients to system servers facilitates ensuring that each service provider within the system exhibits at least one desired functional behavior. For example, adding an extender execution path and/or an application server method execution path to a proxy so that the extender and/or application server method is executed prior to execution of the desired service provider method ensures that, in the user's view, the service provider method includes the functionality exhibited by the extender. Enabling a given service provider method and/or service provider or requiring all service provider methods and/or service providers to exhibit a desired functionality using an extender and/or an application server method facilitates maintaining the system without a need to develop and debug each service provider and/or service provider method.

It should be noted that although the present invention is described with respect to automated systems, as will be appreciated by one of ordinary skill in the art, the present invention may also apply to any system and/or manufacturing process. Further, although the present invention is described with respect to a directory of assets, as will be appreciated by one of ordinary skill in the art, the present invention may also apply to any accumulation of assets that operates as described herein.

In summary, one embodiment of a method for normalizing client interactions with service providers includes receiving a request for a desired service provider method interface from a client, searching a directory for an extender that is associated with the desired service provider method, and returning a proxy to the client, the proxy including at least one of an extender execution path and a method execution path.

In one embodiment, searching a directory for an extender includes registering at least one service provider in the directory, registering at least one extender in the directory, and associating the extender with at least one of the service provider and an application server method. In an alternative embodiment, registering a service provider in the directory includes inserting into the directory at least one of a load location of the method of the service provider, at least one dependency on additional service providers, factory information, interfaces supported by the service provider, and a unique name of the service provider.

Moreover, in another alternative embodiment, registering an extender in the directory includes inserting into the directory at least one of a load location of the extender and at least one dependency on a different extender. In a further alternative embodiment, registering an extender in the directory includes inserting into the directory a list of associated service providers including at least one of all service providers, a specific class of service provider, a list of individual service providers, and a classification of the extender as one of client-side, server-side, and client-server.

Further, in one embodiment, the method also includes returning a proxy to the client, the proxy including at least one of an extender execution path and a method execution path. In an alternative embodiment, returning a proxy to the client includes embedding at least one extender into the proxy such that the proxy includes at least one of an extender execution path, a desired service provider method execution path, and an application server method execution path. Moreover, in another alternative embodiment, the method also includes executing at least one of the extender, the desired service provider method, and an application server method.

As used herein, an element or step recited in the singular and proceeded with the word “a” or “an” should be understood as not excluding plural elements or steps, unless such exclusion is explicitly recited. Further, references to one embodiment of the present invention are not intended to be interpreted as excluding the existence of additional embodiments that also incorporate the recited features.

Exemplary embodiments of systems and methods for dynamic code extension are provided. The systems and methods shown are not limited to the specific embodiments described herein, but rather, components of the system may be utilized independently and separately from other components described herein. Further, steps described in the method may be utilized independently and separately from other steps described herein.

While the invention has been described in terms of various specific embodiments, those skilled in the art will recognize that the invention can be practiced with modification within the spirit and scope of the claims.

What is claimed is:

1. A method for normalizing client interactions with service providers, said method comprising:
receiving a request for a desired service provider method interface from a client;
searching a directory for an extender that is associated with the desired service provider method; and
returning a proxy to the client, the proxy including at least one of an extender execution path and a method execution path.

2. A method in accordance with claim 1 wherein searching a directory for an extender further comprises:
registering at least one service provider in the directory, the at least one service provider including the desired service provider method;
registering at least one extender in the directory; and
associating the at least one extender with at least one of the at least one service provider and an application server method.

3. A method in accordance with claim 2 wherein registering at least one service provider in the directory further comprises inserting into the directory at least one of a load location of the at least one method of the service provider, at least one dependency on additional service providers, factory information, interfaces supported by the service provider, and a unique name of the service provider.

4. A method in accordance with claim 2 wherein registering at least one extender in the directory further comprises inserting into the directory at least one of a load location of the extender and at least one dependency on a different extender.

5. A method in accordance with claim 4 wherein registering at least one extender in the directory further comprises inserting into the directory a list of associated service providers including at least one of all service providers, a specific class of service provider, a list of individual service providers, and a classification of the at least one extender as one of client-side, server-side, and client-server.

6. A method in accordance with claim 1 wherein returning a proxy to the client further comprises embedding at least one extender into the proxy such that the proxy includes at least one of an extender execution path, a desired service provider method execution path, and an application server method execution path.

7. A method in accordance with claim 1 further comprising executing at least one of the extender, the desired service provider method, and an application server method.

8. A data communication system comprising:
at least one client; and
a server communicatively coupled to said at least one client, said server comprising a plurality of service providers, a plurality of extenders, and a directory, said server configured to:
search said directory for at least one extender of said plurality of extenders, said at least one extender associated with a client-specified service provider of said plurality of service providers;
build a proxy comprising at least one of an execution path for said at least one extender and an execution path for a method;
execute said method using said proxy; and
transmit execution results of said method to said at least one client for display to a user.

9. A data communication system in accordance with claim 8 wherein said at least one client comprises at least one of a user-oriented application and a user-oriented application running within a web browser.

10. A data communication system in accordance with claim 9 wherein said at least one client is configured to:
request a desired interface supported by a desired service provider of said plurality of service providers;
call said method for execution using said proxy; and
display execution results for said method.

11. A data communication system in accordance with claim 8 wherein each service provider of said plurality of service providers comprises a plurality of methods, each said service provider configured to support at least one interface.

12. A data communication system in accordance with claim 8 wherein said directory comprises:
a load location for each service provider of said plurality of service providers;
dependencies of each service provider, said dependencies comprising dependencies on at least one of an additional service provider of said plurality of service providers and an extender of said plurality of extenders.

13. A data communication system in accordance with claim 12 wherein said directory further comprises:
a load location for each extender of said plurality of extenders;
dependencies of each extender, said dependencies comprising dependencies on at least one of a different extender of said plurality of extenders, a service provider of said plurality of service providers, and a classification for each extender as one of client-side, server-side, and client-server.

14. A data communication system in accordance with claim 13 wherein said directory further comprises a list of service providers of said plurality of service providers to which each extender should be applied, said list comprising at least one of all service providers of said plurality of service providers, a specific class of service provider within said plurality of service providers, and individual service providers of said plurality of service providers.

15. A computer program embodied on a computer-readable medium comprising at least one code segment configured to instruct a computer to inject one of an application server method execution path and an extender into a service provider method execution path by:
searching a directory for at least one extender registered in association with a service provider; and
building a proxy including at least one of the service provider method execution path, an extender execution path, and the application server method execution path.

16. A computer program in accordance with claim 15 further comprising at least one code segment configured to instruct a computer to register the service provider in the directory by inserting into the directory at least one of a load location of at least one service provider method of the service provider, dependencies on an additional service provider, factory information, interfaces supported by the service provider, and a unique name of the service provider.

17. A computer program in accordance with claim 15 further comprising at least one code segment configured to instruct a computer to register at least one extender in the directory by inserting into the directory at least one of a load location of the at least one extender, dependencies on an additional extender, and a classification of the at least one extender as client-side, server-side, and client-server.

18. A computer program in accordance with claim 15 further comprising at least one code segment configured to instruct a computer to associate at least one extender with at least one service provider by linking the at least one extender to the at least one service provider in the directory including at least one of all service providers, a specific class of service provider, and a list of individual service providers.

19. A computer program in accordance with claim 15 further comprising at least one code segment configured to instruct a computer to transmit the proxy to a client.

20. A computer program in accordance with claim 15 further comprising at least one code segment configured to instruct a computer to execute a method of the service provider by:
calling the extender for execution according to the extender execution path, wherein the extender is called by one of the proxy and the application server method; and
calling the service provider method for execution according to the service provider method execution path included in the proxy.
